(19) United States
(12) Patent Application Publication
(10) Pub. No.: US 2002/0023956 A1
(43) Pub. Date: Feb. 28, 2002

(54) INFORMATION TRANSMITTING SYSTEM FEATURING TRANSMISSION UPON ALIGNMENT OF A MEMORY AND A WRITING/READING ELEMENT

(76) Inventor: YUICHI KANEKO, KANAGAWA (JP)

Correspondence Address: FROMMER LAWRENCE & HAUG, 745 FIFTH AVENUE- 10TH FL., NEW YORK, NY, 10151, US

(21) Appl. No.: 09/221,563

(22) Filed: Dec. 28, 1998

(30) Foreign Application Priority Data
Jan. 6, 1998 (JP) 10-001116

(51) Int. Cl. G06F 17/60

(52) U.S. Cl. 235/385

(57) ABSTRACT

The information transmitting apparatus according to the invention comprises a video cassette equipped with a memory card and a video tape recorder. The video cassette allows the information to be written and read to and from the memory card in a non-contact manner. The memory card is provided with an antenna. Another antenna for powering the memory card and for information communication with that memory card is attached to a front panel of the video tape recorder. An antenna marking 35 is used to mark the antenna position on the front panel. The antenna of the video tape recorder is faced correctly with the antenna of the memory card by simply aligning the memory card antenna of the video cassette with the antenna marking 35 on the video tape recorder, whereby information communication is executed with ease. The information transmitting apparatus may communicate the information easily and reliably in a non-contact manner.

### BACKGROUND OF THE INVENTION

The present invention relates to an information transmitting apparatus. More particularly, the invention relates to an information transmitting apparatus wherein, when information is generated by writing and reading means and the generated information is written thereby to memory means for storage in a non-contact manner or when information is read from the memory means by the writing and reading means also in a non-contact manner, the writing and reading means has a reference element facilitating alignment of transmitting and receiving means of the memory means with transmitting and receiving means of the writing and reading means, in order to communicate the information.

There exists apparatus for recording various events on a storage medium or reproducing such events from the storage medium. The video tape recorder for recording and reproducing broadcast programs exemplifies such an apparatus. A certain type of video tape recorder is known for its function which, when a video cassette is loaded therein, plays back the a video tape held in the video cassette to judge what the video cassette in question contains. Given the judgment, the video tape recorder may allow relevant program information (representing dates of recordings, recording start times, channel numbers, etc.) stored in the recorder body to be retrieved accordingly for the display onto a display screen.

However, the above type of video tape recorder is incapable of recognizing any programs recorded on a video cassette unless and until the video cassette is loaded.

It is a general object of the present invention to provide an information transmitting apparatus having an auxiliary memory to and from which information about programs recorded on the video cassette is written and read in a non-contact manner. Particularly, it is more specific object of the invention to provide an information transmitting apparatus having memory means that may be manually positioned easily and correctly relative to the writing and reading means to write and read information to and from the memory means in a non-contact manner, for reliable communication.

### SUMMARY OF THE INVENTION

As a solution to the above disadvantage, a video cassette is provided with an auxiliary memory to and from which information about programs recorded on the video cassette is written and read in a non-contact manner. In the case, signals representing program-related information are exchanged between the video cassette and the video tape recorder illustratively by use of an antenna arrangement. Therefore, unless the video cassette is properly positioned manually for alignment with the video tape recorder, communication of the program information cannot take place therebetween.

In carrying out the invention and according to one aspect thereof, there is provided an information transmitting apparatus comprising memory means and writing and reading means. Each of the memory means and the writing and reading means has transmitting and receiving means for communicating information to be written or read out. The writing and reading means has a reference element for aligning the transmitting and receiving means of the memory means with the transmitting and receiving means of the writing and reading means. The writing and reading means may include indicating means for indicating status of information communication with the memory means.

Preferably, antennas may be used to constitute two transmitting and receiving means: a first for the memory means for information storage, and a second for the writing and reading means either for generating information and writing the generated information to the memory means in a non-contact manner or for reading information from the memory means also in a non-contact manner. The writing and reading means may include a reference element for antenna position alignment. The reference element may be a marking denoting an antenna position or may be a concave part formed so as to conform to a shape of the memory means.

The writing and reading means may comprise indicating means constituted illustratively by a buzzer, light-emitting elements or a display device. The indicating means indicates status of information communication with the memory means in the form of a beep sound effected by the buzzer, illumination by the light-emitting elements, or a display by the display device.

A further understanding of the nature and advantages of the invention may be realized by reference to the following portions of the specification and drawings.

### BRIEF DESCRIPTION OF THE DRAWING

FIG. 1 is a schematic view of a video cassette to which a memory means, namely, a memory card used in the information transmitting apparatus of the invention is attached;

FIG. 2 is a schematic block diagram of the memory card;

FIG. 3 is an external view of the writing and readingmeans, namely, a video tape recorder used in the information transmitting apparatus of the invention;

FIG. 4 is a schematic cross-sectional view taken along line I-I′ of FIG. 3;

FIG. 5 is a schematic cross-sectional view taken along line II-II′ of FIG. 3;

FIG. 6 is an external view of another writing and reading means, namely, video tape recorder, used in the information transmitting apparatus of the invention;

FIG. 7 is a schematic cross-sectional view taken along line III-III′ of FIG. 6;

FIG. 8 is an external view of still another writing and reading means, namely, the video tape recorder used in the information transmitting apparatus of the invention;

FIG. 9 is a schematic block diagram of the video tape recorder;

FIG. 10 is a schematic block diagram of a transmission and reception processing unit used in the information transmitting apparatus of the invention;

FIG. 11 is a schematic view of a video cassette integrated with a cassette memory;

FIG. 12 is a flowchart of steps in which a manual positioning-prompted display operation is carried out;

FIGS. 13A and 13B are schematic views of typical display screens on a display device; and

FIG. 14 is a flowchart of steps in which a maximum available recording time is calculated.

### DETAILED EXPLANATION OF THE PREFERRED EMBODIMENTS

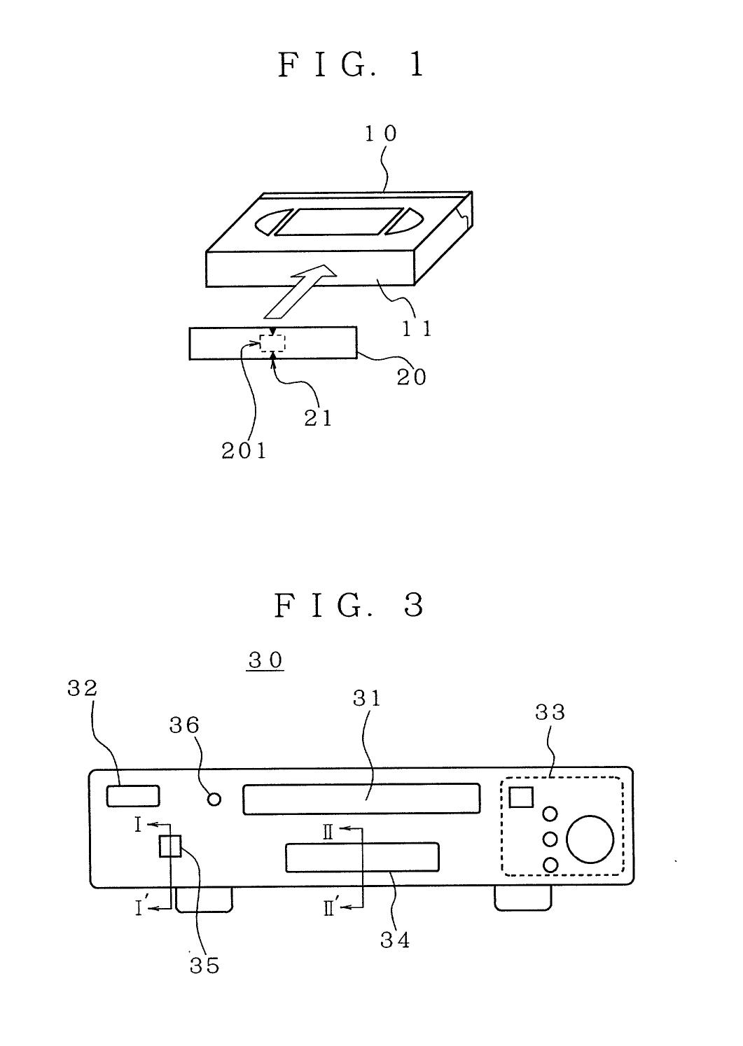

A preferred embodiment of this invention will now be described with reference to the accompanying drawings. FIG. 1 is a schematic view of a video cassette 10. To a concave part 11 of the video cassette 10 is attached illustratively a non-contact type memory card 20 (simply called the memory card hereunder) as an auxiliary memory. The memory card 20 as memory means has an antenna position indication 21 for determining the position of an antenna 201, to be described later.

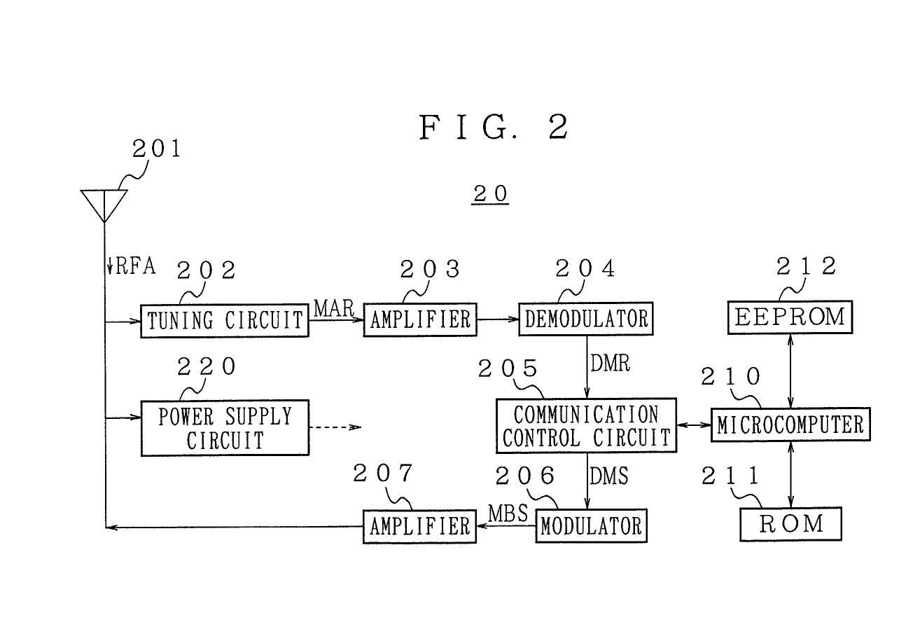

The memory card 20 is structured as depicted in FIG. 2. The antenna 201 as transmitting and receiving means receives radio waves from an antenna 41a or 41b that serves as transmitting and receiving means of a video tape recorder 30, to be described later. A signal RFA received via the antenna 201 is supplied to a tuning circuit 202 and a power supply circuit 220. The tuning circuit 202 selects a modulated signal MAR having a predetermined carrier frequency out of the signal RFA sent from the antenna 201. The modulated signal MAR acquired by the tuning circuit 202 is amplified by an amplifier 203 up to a predetermined level before being fed to a demodulator 204. The demodulator 204 demodulates the modulated signal MAR to obtain a received data signal DMR. The received data signal DMR is supplied to a microcomputer 210 via a communication control circuit 205.

The microcomputer 210 is connected to a ROM (read only memory) 211. Using control programs stored in the ROM 211, the microcomputer 210 controls various parts of the memory card 20. The microcomputer 210 is also connected to an EEPROM (electrically erasable and programmable read only memory) 212. The memory 212 stores information about programs (dates of recordings, recording start times, channel numbers, recorded program positions, etc.) contained in the received data signal DMR. When information is read from the EEPROM 212 by the microcomputer 210 to generate a transmitted data signal DMS, the generated signal DMS is fed to a modulator 206 via the communication control circuit 205.

The modulator 206 modulates the transmitted data signal DMS thus supplied into a signal MBS having a predetermined carrier frequency. The modulated signal MBS obtained by the modulator 206 is amplified by an amplifier 207 up to a signal level sufficiently high for communication before being forwarded to the antenna 201. In turn, the antenna 201 transmits the modulated signal MBS at the carrier frequency.

The power supply circuit 220 generates electric power by exploiting electromagnetic coupling between the antenna 201 on the one hand and the antenna 41a or 41b of the video tape recorder 30 on the other hand. The power thus generated is used by the memory card 20.

FIG. 3 is an external view of the video tape recorder 30. A front panel of the video tape recorder 30 has a loading port 31 through which a video cassette can be loaded, a power switch 32, an operation input part 33 for switching video tape recorder operations, and a display unit 34 for displaying operation status and related data. Also furnished are an antenna marking 35 indicating where the antenna 41a is located inside the front panel of the video tape recorder 30, and a communication indicator 36 indicating whether communication is in progress with the memory card 20 of a video cassette by use of the antenna 41a.

Whereas the memory card 20 is powered for its activity and for communication through electromagnetic coupling, the power is not available if the antenna 201 of the memory card 20 is not correctly aligned with the antenna 41a or 41b of the video tape recorder 30. To ensure communication between the antenna 201 of the memory card 20 and the antenna 41a of the video tape recorder 30 requires manually positioning the video cassette 10 close to the video tape recorder 30 using the antenna marking 35 (reference element) at the front panel in such a manner that the antenna 201 of the memory card 20 is faced with the antenna 41a inside the front panel.

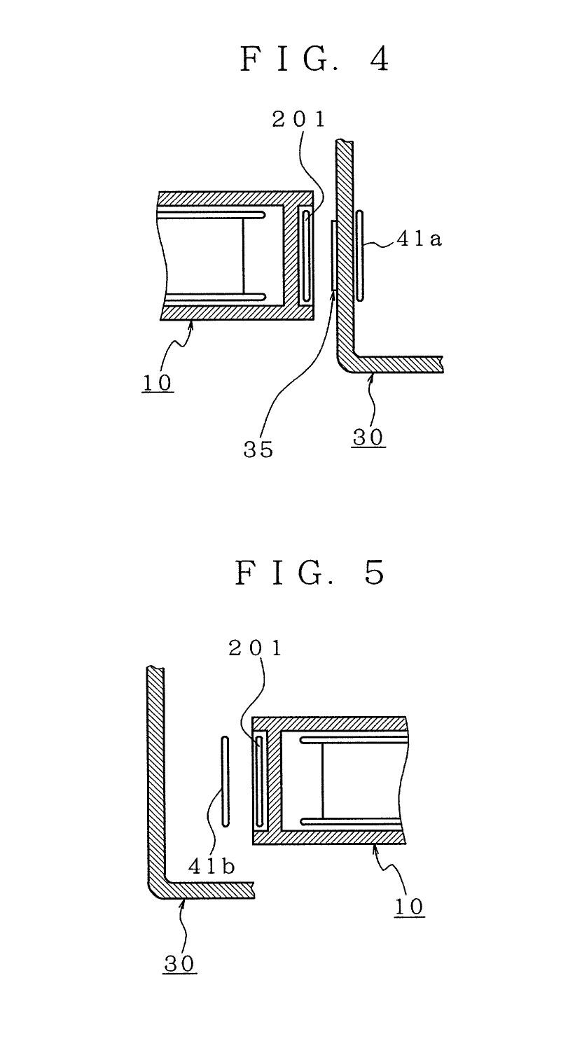

FIG. 4 is a schematic cross-sectional view taken along line I-I′ of FIG. 3, showing how the video cassette 10 is positioned manually close to the video tape recorder 30. As shown in FIG. 4, the use of the antenna marking 35 makes it easy to position the antenna 201 of the memory card 20 face to face with the antenna 41a of the video tape recorder 30. Electric power used for communication and the activity of the memory card 20 is tapped from electromagnetic coupling between the antennas 201 and 41a.

FIG. 5 is a schematic cross-sectional view taken along line II-II′ of FIG. 3. When the video cassette 10 is loaded in the video tape recorder 30 as depicted in FIG. 5, the antenna 201 of the memory card 20 is faced with the antenna 41b inside the video tape recorder 30. Thus the electric power used by the memory card 20 for its activity and for communication is tapped from electromagnetic coupling between the antennas 201 and 41b.

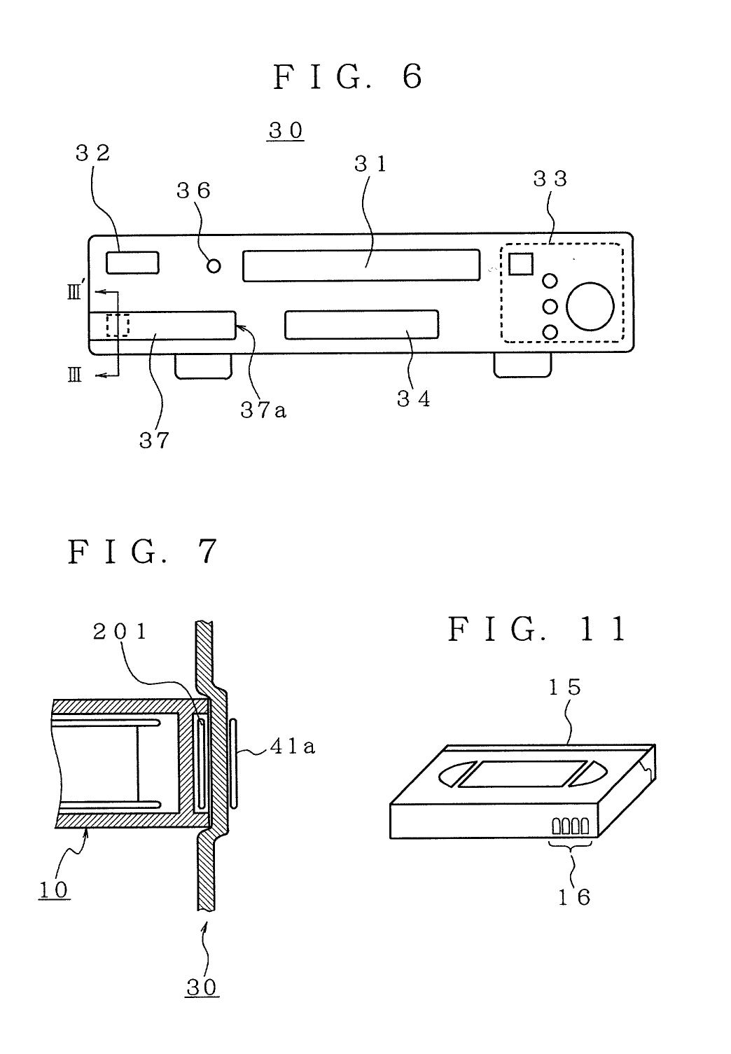

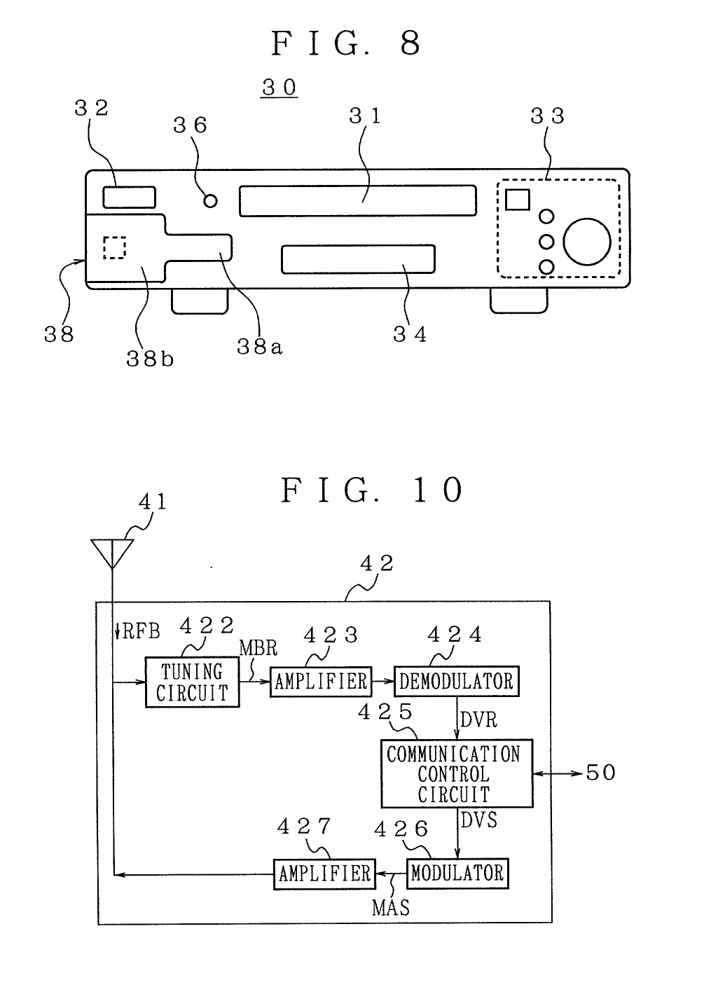

The antenna marking 35, as described above, is used to position manually the video cassette 10 close to the video tape recorder 30 so as to align the antennas 201 and 41a. Alternatively, a concave part 37 may be formed as another reference element at the front panel of the video tape recorder 30, as illustrated in FIG. 6.

The concave part 37 is made slightly wider than the height of the video cassette 10. The antenna 41a is located inside the front panel where the concave part 37 is formed. The antenna 41a is located in such a manner that, when the video cassette 10 is so positioned manually as to let one of its edges contact an edge 37a of the concave part 37, the antenna 41a comes face to face with the antenna 201 of the memory card 20.

FIG. 7 is a schematic cross-sectional view taken along line III-III′ of FIG. 7. As shown in FIG. 7, the antennas 201 and 41a are aligned correctly by simply positioning the video cassette 10 manually close to a suitable location where the concave part 37 is formed. This ensures communication and provision of electric power.

There may be a case where a card type memory such as an IC card is equipped with the same circuits and antennas for data transmission and reception as those of the memory card 20. That card type memory may be used illustratively to store booking information about programs to be recorded and to supply the information to the video tape recorder 30. In such a case, a concave part may be formed so as to conform to the shape of the card type memory. As is the case with the video cassette 10, the concave formation to accommodate the card type memory also makes it easy to align the antennas.

When both the memory card 20 attached to the video cassette 10 and the card type memory are used to communicate information, separate concave parts may be formed to conform to the shapes of the respective memories. Alternatively, a single concave part 38 may be formed so as to conform simultaneously to the shapes of both the memory card 20 of the video cassette 10 and the card type memory, with the antenna 41a being shared. An area 38a of the concave part 38 corresponds to the memory card of the video cassette 10; an area 38b corresponds to the card type memory.

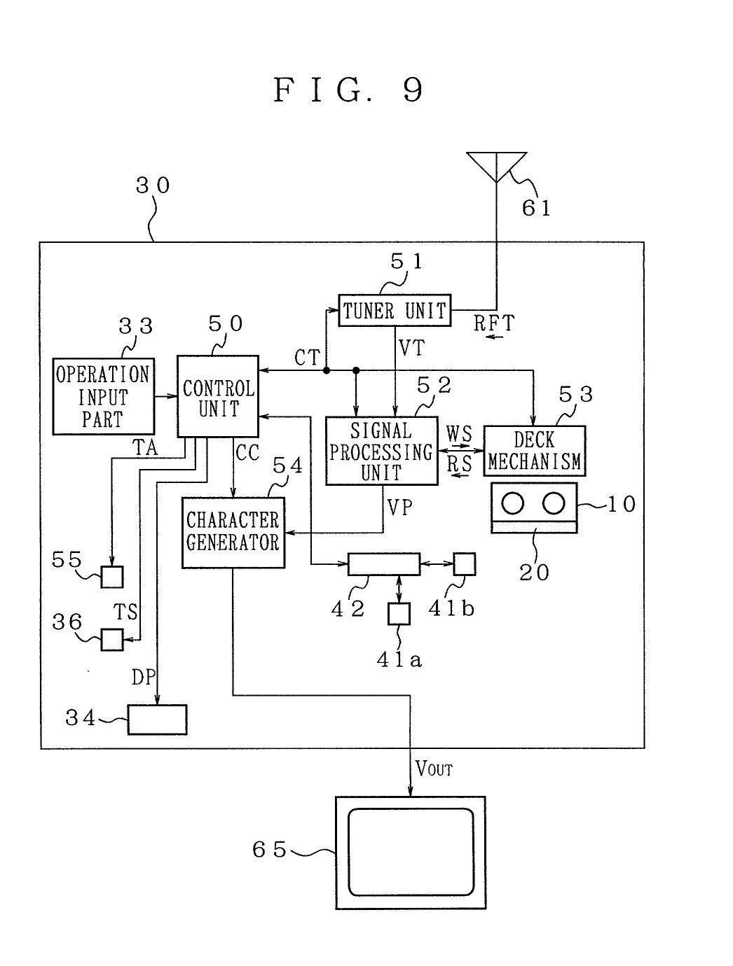

FIG. 9 is a schematic block diagram of the video tape recorder 30. The antennas 41a and 41b inside the video tape recorder 30 are connected to a transmission and reception processing unit 42 constituting part of the writing and reading means of the invention. The transmission and reception processing unit 42 is connected to a control unit 50 made of a microcomputer constituting another part of the writing and reading means. Communication takes place between the memory card 20 and the control unit 50. The transmission and reception processing unit 42, the antennas 41a and 41b, and the control unit 50 make up communicating means of this invention.

FIG. 10 is a schematic block diagram of the transmission and reception processing unit 42. Using the antenna 41a or 41b, the unit 42 receives radio waves coming from the antenna 201 of the memory card 20. The signal RFB received via the antenna 41a or 41b is supplied to a tuning circuit 422.

The tuning circuit 422 selects a modulated signal MBR having a predetermined carrier frequency out of the received signal RFB. The modulated signal MBR obtained by the tuning circuit 422 is amplified by an amplifier 423 up to a predetermined level before being fed to a demodulator 424. The demodulator 424 demodulates the modulated signal MBR to acquire a received data signal DVR. The received data signal DVR is supplied to the control unit 50 via a communication control circuit 425.

The control unit 50 provides a transmitted data signal DVS containing information about programs. The transmitted data signal DVS is fed to a modulator 426 via the communication control circuit 425.

The modulator 426 modulates the transmitted data signal DVS to obtain a signal MAS having a predetermined carrier frequency. The modulated signal MAS acquired by the modulator 426 is amplified by an amplifier 427 up to a signal level sufficiently high for communication before being sent to the antenna 41a or 41b. The antenna 41a or 41b then transmits the modulated signal MAS at the carrier frequency.

A signal RFT is obtained when broadcast radio waves are received by an antenna 61 shown in FIG. 9. The signal RFT is fed to a tuner unit 51. The tuner unit 51 selects broadcast waves having a specific frequency to generate a video signal VT. The video signal VT is supplied to a signal processing unit 52. The signal processing unit 52 processes the video signal VT into a write signal WS. The write signal WS is fed to a deck mechanism 53. In the deck mechanism 53, a rotary head (not shown) records the write signal WS to a video tape in the video cassette 10.

When the video tape is played back, a reproduced signal RS is sent from the deck mechanism 53 to the signal processing unit 52. The signal processing unit 52 processes the reproduced signal RS to generate a reproduced video signal VP. The reproduced video signal VP is supplied to a character generator 54.

The character generator 54 constituting part of display controlling means of this invention generates a video signal VC based on a control signal CC from the control unit 50. Said video signal VC is used to display information about programs. The character generator 54 and the control unit 50 make up the display controlling means. In the character generator 54, the generated video signal VC is multiplexed with the reproduced video signal VP from the signal processing unit 52. The resulting signal from the character generator 54 is a video output signal VOUT that is output by the video tape recorder 30. Alternatively, the reproduced video signal VP and selected components of the generated video signal VC are multiplexed to make up a video output signal VOUT that comes out of the video tape recorder 30. The video output signal VOUT is supplied to a display device 65. In turn, the display device 65 displays reproduced images and information that denotes programs.

The control unit 50 of the video tape recorder 30 generates a control signal CT for controlling the tuner unit 51, signal processing unit 52 and deck mechanism 53. At the same time, the control unit 50 performs communication with the memory card 20 attached to the video cassette 10. Furthermore, the control unit 50 generates the control signal CC based on the received data signal DVR from the transmission and reception processing unit 42. The control unit 50 is connected to the operation input part 33 that allows the video tape recorder 30 to be switched in operation. The switching of tape recorder operations may be carried out alternatively by use of a remote controller or like device over a telephone line. A display signal DP is sent from the control unit 50 to the display unit 34. Given the signal DP, the display unit 34 indicates operation status and related data.

The communication indicator 36 constituting part of the indicating means connected to the control unit 50 gives an indication, based on an indication control signal TS, about communication status at the antenna 201 of the memory card 20 and at the antenna 41a of the video tape recorder 30.

Illustratively, the communication indicator 36 is composed of a light-emitting diode that lights or blinks to indicate whether communication is in progress or is terminated. Obviously, the display unit 34 may double alternatively as the indicating means displaying the communication status.

An audio output unit 55 connected to the control unit 50 outputs a sound regarding the communication status at the antennas 201 and 41a on the basis of an audio signal TA from the control unit 50. Illustratively, the audio output unit 55 is composed of a buzzer that sounds upon completion of communication. The audio output unit 55 constitutes part of the indicating means.

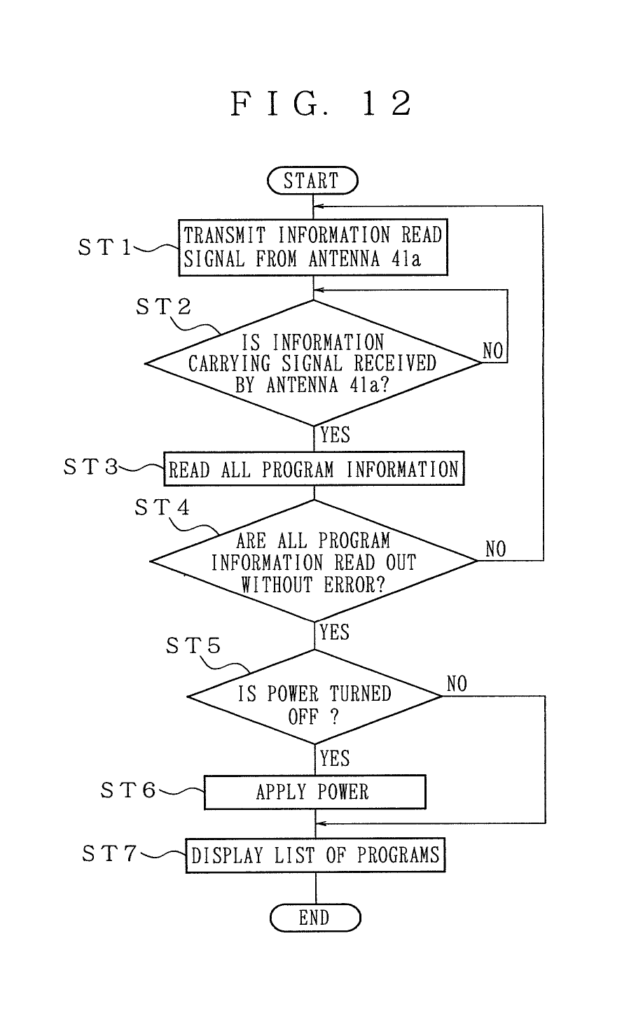

Although the memory card 20 is attached to the video cassette 10 as its auxiliary memory in the above embodiments, this is not limitative of the invention. Another type of memory such EEPROM may be placed as an auxiliary memory or a built-in cassette memory into the video cassette. Such a video cassette 15 comprising a cassette memory has a contact part 16 for communication, as illustrated in FIG. 11. Where the video cassette 15 is to be used by the video tape recorder 30, the latter should have a terminal part for connection with the contact part 16 of the cassette. That terminal part is connected to the control unit 50.

In the video tape recorder 30 of the above constitution, under the signals from the control unit 50, the program information including the recorded position information about programs recorded on a video cassette is stored on the auxiliary memory of that video cassette. When any one of the programs recorded on the video cassette is to be selected, the program information is read from the auxiliary memory of the cassette. On the basis of the program information thus retrieved, the control signal CC is generated and supplied to the character generator 54. Given the control signal CC, the character generator 54 generates the video signal VC for information display and sends the generated signal to the display device 65. In turn, the display device 65 displays on its screen the information about the programs.

The display device 65 also displays a blank tape portion based on the information read from the auxiliary memory of the video cassette. Specifically, a display “BLANK TIME” appears on the screen indicating the longest available blank portion of the tape based on the recorded positions of the programs deemed no longer needed and on that portion of the tape which is judged unrecorded.

The embodiment of the invention works as follows: Programs are recorded successively on the video cassette 10. At the end of each of the recorded programs and upon completion of the recording operation, program information about the recorded program positions is stored successively into the memory card 20 of the video cassette 10.

If any of the programs recorded on the video cassette 10 is regarded as unnecessary, the program information about that program is erased from the memory card 20. When a new program is recorded, program information about the newly accommodated program is stored into the memory card 20. At the same time, that portion of the recorded program position information which concerns any overlapping recordings is erased. If a new program is overwritten onto a previously recorded program to such an extent that the already recorded program becomes shorter than a predetermined period of time (e.g., 15 minutes) in duration, then the program information about that old program is erased from the memory card 20.

The program information kept in the memory card 20 is retrieved for the display onto the display device 65 on three occasions: (a) when the video cassette 10 is positioned manually close to the video tape recorder 30 to get the antenna 201 of the memory card 20 faced with the antenna 41a of the video tape recorder 30; (b) when the video cassette 10 is loaded into the video tape recorder 30; or (c) when program search mode is selected by the operation input part 33 or remote controller of the video tape recorder 30 in order to select programs from those recorded on the video cassette 10.

FIG. 12 is a flowchart of steps in which the video cassette 10 is positioned manually close to the video cassette recorder 30 to read program information from the memory card 20.

In step ST1 of FIG. 12, a signal for prompting the information to be read from the memory card 20, e.g., an address signal denoting positions at which the information is recorded, is modulated and transmitted via the antenna 41a.

In step ST2, a check is made to judge whether the signal representing the information is received by the antenna 41a. When the video cassette 10 is not positioned manually close to the video tape recorder 30, no signal carrying the information is fed to the antenna 41a and then step ST2 is reached again. When the video cassette 10 is manually positioned close to a suitable location of the video cassette recorder 30, relevant parts of the memory card 20 on the video cassette 10 are powered. On the basis of the signal prompting information retrieval, which is received from the antenna 41a, program information is read from the memory card 20 and transmitted via the antenna 201. The signal sent from the antenna 201 is received by the antenna 41a. Hence comes the judgment that the signal representing the information has been received, and step ST3 is reached. In step ST3, all program information in the memory card 20 is read out. Step ST3 is followed by step ST4.

In step ST4, a check is made to judge whether all program information has been read out without error. When any error is detected in step ST4, step ST1 is reached again; when no error is detected, step ST5 is reached.

In step ST5, a check is made to judge whether the video tape recorder 30 is turned off. When the video tape recorder 30 is found to be turned off, the machine is turned on in step ST6 before step ST7 is reached. When the video tape recorder 30 is judged to be on in step ST5, step ST7 is reached immediately.

In step ST7, the display device 65 displays a manual positioning-prompted display screen based on the program information and related data from the memory card 20. This completes the manual positioning-prompted display operation.

While the program information is being read, the communication indicator 36 as shown in FIG. 9 indicates communication status. When all program information has been retrieved and displayed in the form of the manual positioning-prompted display screen, the audio output unit 55 outputs a sound verifying the end of the manual positioning-prompted display operation.

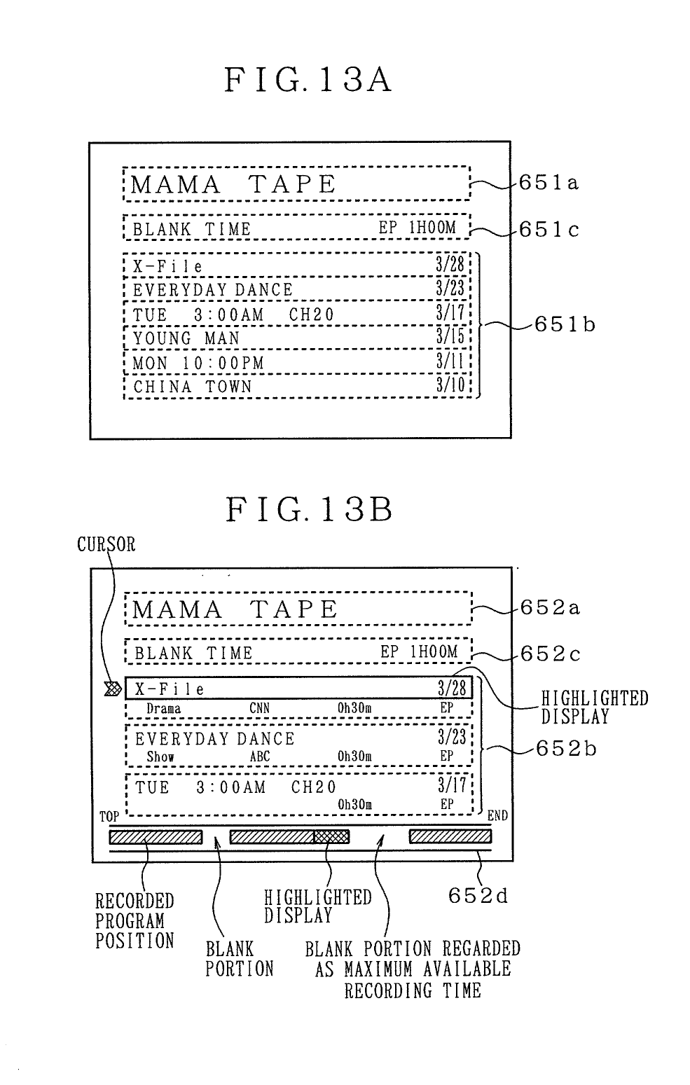

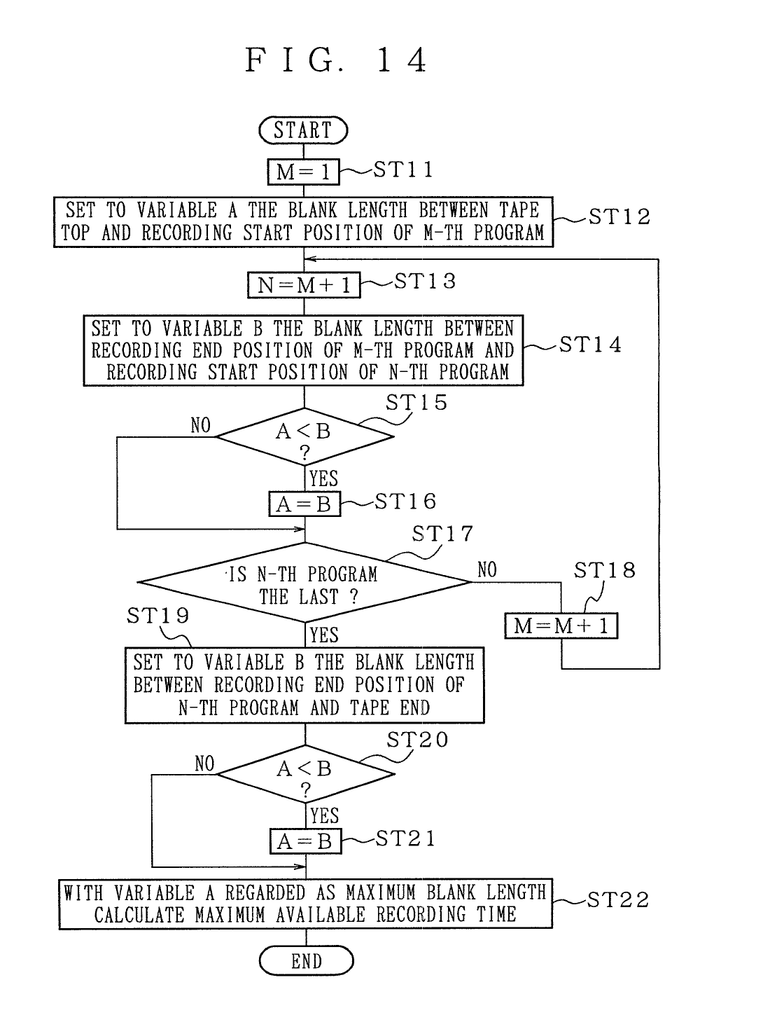

FIG. 13A shows a typical manual positioning-prompted display screen. A tape title is displayed in a tape title display area 651a on the basis of the program information retrieved from the memory card 20. A program display area 651b on the screen displays program information about the programs recorded on the video cassette 10. On a single page of the manual positioning-prompted display screen, illustratively up to six program titles and their recording dates are displayed chronologically to permit easy verification of the programs recorded on the video cassette 10. The subsequent page or pages of the screen are called up by operating a suitable key on the operation input part 33 or remote controller of the video tape recorder 30. A blank display area 651c indicates under the title “BLANK TIME” the maximum available recording time on the video tape in accordance with the program information.

FIG. 14 is a flowchart of steps in which a maximum available recording time is calculated. In step ST11, a variable M is set to 1. Then step ST12 is reached.

In step ST12, recorded program position information included in the program information read from the memory card 20 is used as the basis for calculating a blank length between the tape top and the recording start position of an M-th program from the tape top. The blank length thus calculated is set to a variable A.

In step ST13, the variable M is incremented by 1 and the newly established value is set to a variable N. Step ST13 is followed by step ST14.

In step ST14, a blank length is calculated between the recording end position of the M-th program from the tape top and the recording start position of an N-th program. The blank length thus calculated is set to a variable B, and step ST15 is reached.

In step ST15, the variable A is compared with the variable B. When the variable B is judged to be greater than the variable A, step ST16 is reached. When the variable B is not found to be greater than the variable A, step ST17 is reached.

In step ST16, the value of the variable B is set to the variable A. Step ST16 is followed by step ST17.

In step ST17, a check is made to judge whether the Nth program is the last recorded program, i.e., the program recorded the closest to the tape end. If the N-th program is not judged to be the last recorded program, step ST18 is reached in which the variable M is incremented by 1. With the newly incremented value of the variable M established, step ST13 is reached again. When the N-th program is found to be the last recorded program in step ST17, step ST19 is reached.

In step ST19, a blank length between the recording end position of the N-th program and the tape end is calculated. The blank length thus calculated is set to the variable B. Step ST19 is followed by step ST20.

In step ST20, the variable A is compared with the variable B. If the variable B is judged to be greater than the variable A, step ST21 is reached. If the variable B is not found to be greater than the variable A, step ST22 is reached.

In step ST22, the value of the variable A is established as the maximum blank length. The maximum available recording time is calculated on the basis of that maximum blank length and of a currently selected recording mode of the video tape recorder 30 (e.g., either standard recording mode or long-playing recording mode). This completes the processing of FIG. 14.

The maximum available recording time varies with the recording mode in effect. The screen thus displays the calculated maximum available recording time corresponding to the currently selected recording mode that is also indicated. When recording modes are switched by the operation input part 33 or remote controller of the video tape recorder 30 (constituting mode setting means), the maximum available recording time is again calculated according to the newly selected recording mode. The newly provided recording time is then displayed corresponding to the newly established recording mode that is also indicated.

The manual positioning-prompted display screen is terminated in two cases: when an operation key different from the keys for feeding pages or for switching recording modes is operated, or when a predetermined period of time has elapsed with no operation carried out.

In the manner described, simply positioning the video cassette 10 manually close to a suitable location of the video tape recorder 30 causes the display device 65 automatically to display information about programs recorded on the video cassette 10. The programs recorded on the video cassette 10 are thus easily known without having to load the cassette into the video tape recorder 30. With one video cassette 10 after another positioned manually close to a suitable location of the video tape recorder 30, the display unit 34 of the tape recorder allows the user to find out easily which video cassette is needed to videotape a new program in its entirety based on the maximum available recording time displayed on the small display area of the unit 34; there is no need to utilize the display device 65. When a tape title is displayed on the display unit 34 for each video cassette, it is easy to find the video cassette containing the desired program without recourse to the display device 65.

Program information is read from the memory card 20 via the antenna 41b and displayed as a program search screen on the display device 65 when the video cassette 10 is loaded into the video tape recorder 30, or when, with the video cassette 10 loaded in the video tape recorder 30, the operation input part 33 or remote controller of the video tape recorder 30 is operated to select program search mode in which programs recorded on the video cassette 10 are selected. FIG. 13B shows a typical program search screen that appears on the display device 65.

A tape title display area 652a on the program search screen displays a tape title. A program display area 652b indicates the information about the programs recorded on the video cassette. In addition to program titles and their recording dates, the program search screen also displays program categories, broadcasting station names, recording time periods and recording modes. When the program titles are not stored, then the days of the week on which programs are recorded, their recording start times, and the relevant channel numbers are displayed. As is the case with the manual positioning-prompted display screen, a blank display area 652c indicates a maximum available recording time along with a recording mode.

The program search screen also includes a tape bar display 652d indicating recorded program positions on the tape. When a program is selected with a cursor moved on the screen by operation of the operation input part 33 or remote controller, the program pointed to by the cursor is highlighted for distinction from the other program indications. Highlighting typically involves changing colors and/or brightness of the selected program title and the corresponding date of recording, or giving the indications in question in a three-dimensional fashion. The tape bar display 652d also highlights the recorded position of the cursor-indicated program (shown shaded in FIG. 13B) for distinction from the recorded positions of the other programs.

When the cursor is set to the position of the blank display area 652c, that area is highlighted. At the same time, in the tape bar display 652d, the longest available blank portion has its display attributes changed for distinction from the other blank tape portions. For example, an external frame of that position of the tape bar display which corresponds to the longest available blank portion is changed in color.

When a video cassette 10 to which a memory card 20 is attached is loaded in the video tape recorder 30, with the information from the memory card 20 being referenced or edited on the screen, the transmission or reception of information about any other video cassette via the antenna 41a is halted. This arrangement is designed to prevent edited contents of the memory card of the currently loaded video cassette from altering contents of the memory card of any other video cassette that may be manually positioned close to the video tape recorder 30.

In the manner described, a maximum available recording time is displayed when a video cassette 10 with a memory card 20 is manually positioned close to the video tape recorder 30 or when a video cassette having an auxiliary memory is loaded into the video tape recorder 30. This makes it easy to determine whether a desired program in its entirety can be recorded on a video cassette at hand.

The embodiments above have been shown to use the video cassette 10 equipped with the memory card 20. In the above embodiments, the information about programs recorded on the video cassette 10 by the video tape recorder 30 has been shown to be written to the memory card 20 of the cassette, and the program information has been shown to be subsequently read from the memory card 20. However, the information transmitting apparatus of the invention is not adapted solely to the video tape recorder 30 involving the use of the video cassette 10 with the memory card 20 and of the card type memory. Alternatively, the inventive apparatus may be adapted to devices which utilize a disk type storage medium or other recording media.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An information transmitting apparatus comprising:
memory means for allowing information to be written and read thereto and therefrom in a non-contact manner; and
writing and reading means either for generating information and writing the generated information to said memory means in a non-contact manner or for reading information stored in said memory means in a non-contact manner;
wherein each of said memory means and said writing and reading means has transmitting and receiving means for communicating the information either to be read or to be written; and
wherein said writing and reading means has a reference element for aligning the transmitting and receiving means of said memory means with the transmitting and receiving means of said writing and reading means.

2. The information transmitting apparatus according to claim 1, wherein said reference element is a marking.

3. The information transmitting apparatus according to claim 1, wherein said reference element is a concave part formed so as to conform to a shape of said memory means.

4. The information transmitting apparatus according to claim 1, further comprising indicating means for indicating status of information communication with said memory means.

5. The information transmitting apparatus according to claim 3, wherein said concave part is positioned in such a manner that when an edge of said concave part comes into contact with a side of said memory means, the transmitting and receiving means of said memory means is faced with the transmitting and receiving means of said writing and reading means.

6. The information transmitting apparatus according to claim 1, further comprising a storage medium, wherein said memory means is integrated either with the storage medium or with an enclosure incorporating said storage medium, said memory means storing information about events recorded on said storage medium.

7. The information transmitting apparatus according to claim 3, wherein said concave part corresponds to a plurality of types of memory means.

8. The information transmitting apparatus according to claim 3, wherein said writing and reading means comprises a plurality of reference elements, each of said reference elements corresponding to a different type of memory means.

9. The information transmitting apparatus according to claim 6, wherein said storage medium is a video tape.

10. The information transmitting apparatus according to claim 6, wherein said storage medium is a disk.

11. A recording and/or reproducing system comprising:
memory means integrated either with a storage medium or with an enclosure incorporating said storage medium, said memory means allowing information about events recorded on said storage medium to be written and read to and from said memory means in a non-contact manner; and
writing and reading means either for generating information about events recorded on said storage medium and writing the generated information to said memory means in a non-contact manner, or for reading information stored in said memory means in a non-contact manner;
wherein each of said memory means and said writing and reading means has transmitting and receiving means for communicating the information either to be read or to be written; and
wherein said writing and reading means has a reference element for aligning the transmitting and receiving means of said memory means with the transmitting and receiving means of said writing and reading means.

12. The recording and/or reproducing system according to claim 11, wherein said reference element is a marking.

13. The recording and/or reproducing system according to claim 11, wherein said reference element is a concave part formed so as to conform to a shape of said memory means.

14. The recording and/or reproducing system according to claim 11, further comprising indicating means for indicating status of information communication with said memory means.

15. The recording and/or reproducing system according to claim 13, wherein said concave part is positioned in such a manner that when an edge of said concave part comes into contact with a side of said memory means, the transmitting and receiving means of said memory means is faced with the transmitting and receiving means of said writing and reading means.

16. The recording and/or reproducing system according to claim 13, wherein said concave part corresponds to a plurality of types of memory means.

17. The recording and/or reproducing system according to claim 13, wherein said writing and reading means comprises a plurality of reference elements, each of said reference elements corresponding to a different type of memory means.

18. The recording and/or reproducing system according to claim 11, wherein said storage medium is a video tape.

19. The recording and/or reproducing system according to claim 11, wherein said storage medium is a disk.
